(19) United States
(12) Patent Application Publication
(10) Pub. No.: US 2009/0164030 A1
(43) Pub. Date: Jun. 25, 2009

(54) METHOD FOR PROGRAMMING AND/OR DIAGNOSING A PROGRAMMABLE CONTROLLER

(76) Inventors: Stephan Schultze, Lohr (DE); Wolfgang Paul, Lohr (DE)

Correspondence Address: STRIKER, STRIKER & STENBY, 103 EAST NECK ROAD, HUNTINGTON, NY, 11743, US

(21) Appl. No.: 12/339,210

(22) Filed: Dec. 19, 2008

(30) Foreign Application Priority Data
Dec. 22, 2007 (DE) 10 2007 062 453.2

(51) Int. Cl. G05B 11/01

(52) U.S. Cl. 700/26

(57) ABSTRACT

The present invention relates to a method for programming and/or diagnosing a stored-program controller that includes at least one programmable function block, a specified programming system being used for programming, and, within the scope of this programming system, variables are specified and information-exchange sequences are used for programming; according to the present invention, results of the programming or diagnosis are output via a display device during at least one programming mode, and the information-exchange sequences are assigned to the function block and are made available as predefined information-exchange sequences of this programmable function block.

The present invention relates to a method for programming and diagnosing a stored-program controller (SPC). Controllers of this type are used in automation to control method sequences in machines and systems, and to control individual drives of these systems. More specifically, the present invention may be used within the scope of engineering automation devices and networks that contain a stored-program controller. When controllers of this type are programmed, it is known to provide a certain error search mode (debug mode), in the case of which inputs and outputs are depicted using an “on-line status display” as numerical values but without reference to the logical function of the function block. As a result, only numerical values may be displayed, but it is not possible to display a prepared depiction of the functionality or an overview.

In the prior art, SPC programming systems are used to program SPC controllers of this type. The programming of stored-program controllers is often carried out using programming languages per IEC 61131-3 (e.g. using ST: structured text; FUP: functional plan; LAD: ladder diagram, etc.). The SPC programming in the prior art is very flexible and, therefore, essentially any sequences may be controlled.

SPC programming systems that are known from the prior art typically include an interface, with the aid of which SPC programs and SPC function blocks (FB) may be created in various languages or dialects. It is common to instantiate these function blocks, which means that every FB must be declared and defined individually and uniquely, as if it were a variable, when it is used.

As mentioned above, the debug mode is provided to diagnose the programs or function blocks that are created, and, with the aid of which the state of the SPC variables may be visualized in the context of the programming interface. This takes place with the aid of a status display, the appearance of which differs depending on which programming language is used.

It is also common to subdivide the SPC programs and FBs into a declaration part and an implementation part; the SPC variables and FB entities are instantiated in the declaration part, and the functionality is programmed in the implementation part. The term “instantiate” means to define or create the particular variables and entities.

Values of SPC variables may be read, modified, and forced within the scope of the above-mentioned debug mode within the programming system. “Forcing” means to permanently set a variable to a predefinable value. The above-mentioned status display also makes it possible, within the context of a FB, to depict values internal to a FB and which may not be called up outside of the FB. It is possible, therefore, to depict internal states of a FB.

It is also known that watch windows in which any number of variables—which may be filled out—may be viewed in groups and in table form are included for further-reaching diagnostic purposes. It is also possible to simplify the selection of these depictable variables using searchable (browsable) lists; in this case, the names of the particular variables need not be known or entered exactly.

It is also known from the prior art to create special diagnostic dialogs for the programmed function blocks (FBs) within the context of a user interface (HMI). These dialogs make it possible to display and to input or output SPC variables. It is not possible to force variables in this case, however; it is only possible to read or write. Nor do the dialogs in the prior art exist in an automatically created relationship with the FB, i.e. they are detached from this FB in another context of a graphical dialog system, and are therefore not a component of the “function block” object.

It is also known to provide variables with the property “private” in the SPC programming system. These variables are only used internally in an SPC FB and are not visible from the outside. These variables of FBs may not be depicted in a user interface (HMI), either; only the data that are present at the calling limits of the FBs may be depicted, these data being internal variables, calling parameters, and return values which may be read from the outside. The reference data types, e.g. pointer variables and “VAR_IN_OUT data types of SPC” are not depicted in the programming interfaces today, either.

The prior art therefore has the disadvantage that it is not possible using the known SPC programming systems to create a link between FB entities and related graphical dialogs in order to depict functional interrelationships between several SPC variables with graphical support. Only text-based (status) displays of FB entities and SPC variables may be displayed within the context of SPC programming systems.

In addition, to use these above-mentioned status displays in the SPC programming system, a deep understanding of the use of the particular programming system is required, e.g. knowledge about how to use force dialogs and the watch windows described above.

In graphically oriented displays, it is also not possible to force SPC variables, nor is it possible to access reference data types such as pointers or VAR_IN_OUTs. Nor is it possible to access the above-mentioned internal variables (“private”).

In the prior art, the FB may be coupled to an on-line help based only on the help of the FB itself, i.e. calling up the on-line help merely directs the user to the FB help. There are no further-reaching, direct accesses to descriptions of inputs and outputs of FBs.

The object of the present invention, therefore, is to increase the user-friendliness of the programming and diagnosis of stored-program controllers. An improved possibility for displaying parameters and variables of the controller to the user will also be created. In addition, it will be made possible for users who have no special knowledge of programming to perform a diagnosis themselves.

This object is attained according to the present invention using a method described in claim 1. Advantageous variants of the method are the subject matter of the dependent claims.

In a method according to the present invention for programming and/or diagnosing a stored-program controller having at least one stored-program function block, a specified programming system is used for programming and, within the scope of this programming system, variables are specified, and information-exchange sequences are used for programming. According to the present invention, results of the programming or diagnosis are output via a display device during at least one programming mode, and the information-exchange sequences are assigned to the function block, and they are available as predefined information-exchange sequences of this programmable function block.

“Information-exchange sequences” refer to dialogs in particular, which may be individual dialogs or dialog chains, i.e. a collection of several consecutive dialogs, or which may be a dialog structure, such as dialogs having a tree structure. A dialog therefore describes a democratic information exchange which may take place, in particular, in real time between a device and a person.

It is therefore provided according to the present invention that dialogs that are predefined in a graphical or tabular manner in particular be coupled to related function blocks or function block entities. The dialogs are therefore part of the particular “function block” object and are already present as a property of this function block (FB).

In a preferred method, the information-exchange sequences may be called up from a program that was written for the stored-program controller. More specifically, the dialogs may be preferably called up in the context of the SPC program using the context menu of the FB. This may take place, e.g. using the context menu or by double-clicking a certain ST program line with the FB call in the implementation part, or by double-clicking a line in the declaration of the function block in the declaration part. In addition, it may be made possible to double-click the FB or the program point.

In a further preferred method, a directory of a large number of programmable function blocks is made available, and the information-exchange sequences may be called up or downloaded via this directory. The dialogs are therefore called up here in a searchable list of FB entities, the dialogs not being included here in the context of the SPC program, but rather in a separate list that contains all instantiated FBs.

In addition, at least one variable is set to a predetermined value using an information-exchange sequence. In this preferred method, it is therefore also possible to carry out forcing within the scope of dialogs, as described above. The programming of stored-program controllers is also greatly simplified in this manner.

In a further preferred method, at least one information-exchange sequence contains a picture element. It is therefore preferably possible for a picture element to be output to the user with the actual dialog or within the scope of the actual dialog, the picture element showing, e.g. a partial view of the machine to be diagnosed or the functionality to be diagnosed. In this manner, it may be visualized to the user in a particularly advantageous manner how a certain intervention in the machine, e.g. by setting certain limit values, affects the machine-operating sequence. At the same time, it is possible to output—in addition to the picture element—information about a certain value to be set by the operator. The operator may be informed, e.g. that an acceleration compensation that occurs when setpoint speed values are changed results in a change to a torque limit value as a function of the web width of the material density factor and the actual roll diameter.

In this manner, diagnosing the machine or a functionality is greatly simplified even for operators who are not highly specialized. It is therefore provided here that a logically structured depiction be included in addition to, e.g. a purely table-based depiction. Using the graphical picture elements described, dialogs are made possible that simply depict the parameters to be set or observed, and that depict a set of structural circumstances, and therefore show functional interrelationships in a graphically simpler manner.

In addition, in parameter-based systems, it is possible to display a large number of parameters in table form for diagnostic purposes, it being possible to group the information in a logical manner.

In a further preferred method, the information-exchange sequences may be called up via the implementation part or the declaration part of the SPC program.

By coupling the dialogs with the FBs, it is possible to call up the dialogs in the context. This means that the related dialog may be called up with the context of the FB using a context menu. It is possible, as described above, for this call to be carried out using the implementation part of the SPC program. It is possible, e.g. to click using the right mouse button on a certain program line that contains the FB call-up. This is possible, e.g. in text-based programming languages, in particular with ST (structured text) or STL (instruction list). An analog application is possible in other text-based languages.

It is also possible, e.g. to click the FB in the programming system using a mouse button or a double click. This is preferable for graphically oriented programming languages such as LAD (ladder diagram), FUP (functional plan), or AS (sequence language). This is also possible in an analogous manner in other graphically oriented languages. It is also possible to click directly on a button of the FB in a graphically oriented programming language.

The call may also take place via the declaration part of the SPC program, e.g. by clicking with the right mouse button or via double click on a related line of the declaration of the FB.

Special menus (e.g. pull-down menus) which appear in the context of the FB and the menu line of the programming system may also be created. The context may be specified by the cursor position in the declaration and/or implementation part.

The advantage of this procedure is the resultant transparency of the code, i.e. a dialog may be opened directly at the point of interest even when debugging is being carried out. This is advantageous, in particular, when several entities of the same FB are present. The desired FB entity is referenced immediately by clicking the SPC program.

In a further preferred method, the information-exchange sequences may be called up as a searchable list of all FB entities. This means that a list entry exists for every instantiated FB; the list entry may be selected, thereby making it possible to call up the dialogs in a searchable list of FB entities. The call may also take place in this case, e.g. via mouse click in a list box or a tree-type depiction of FB entities. This list may be advantageously limited to those FBs that also contain an information-exchange sequence. The transparency that exists during diagnosis is increased as a result. The information-exchange sequences are therefore not called up within the program context in this case, either, but rather in a separate list with a separate user menu.

In a further preferred method, internal states of the function block are displayed using at least one information-exchange sequence.

In a further preferred method, it is possible to display variables using access modifiers to depict internal states of the FB, and to display reference data types. These may be, e.g., VAR_IN_OUT or pointers.

In the solutions known from the prior art, which are based on HMIs, i.e. on methods for performing diagnosis using user interfaces, it is not possible to depict internal states of the FBs with “private” access modifiers, nor to depict reference data types. In this case, all interesting internal states would also have to be placed at FB outlets. This is a complex undertaking, however, and results in a depiction that is not transparent, thereby reducing the power of the SPC program.

The depiction of internal states is useful in particular for debugging a FB. FBs often contain internal states in the form of a “state machine” which includes states and certain rules for state transitions. By displaying the internal states, this state machine becomes more transparent to the programmer, thereby enabling the programming to better follow the program flow. The depictability of reference data types is helpful in terms of displaying all interesting data of a FB. Otherwise, the depiction of FB data is greatly limited.

In a further preferred method, help instructions may be called up using an information-exchange sequence. It is possible, e.g. to couple to an on-line help in the dialogs. In the prior art, a SPC programming system typically includes the possibility of calling up a help system. It is known, for instance, to call up the targeted help for this FB by clicking the F1 button in the context of the FB. This may take place in a much more differentiated manner using the dialog-supported depiction provided here. In the particular information-exchange sequence, more refined accesses to the help are possible when the help system is called up. In the case of a complex FB, for instance, which includes several help pages (e.g. 20 pages, depending on the context in the information-exchange sequence using the active cursor position), the correct help page may be called up directly.

In addition, it is particularly preferable for SPC variables as well as other data objects to be depicted in the information-exchange sequences. This is interesting, for example, when the SPC variables and further data objects are present in motion control systems. In parameter-based systems, for example, further system-specific parameters may be depicted in the display of FB-specific data. Examples of further parameters of this type are a display of a task cycle time in the dialog in the context of which the FB is running. The real-time properties of the FB may be visualized in this manner. It is also possible to depict a system parameter in the information-exchange sequence, in order to also display, e.g. a system time in this manner.

Further advantages and embodiments result from the attached drawings:

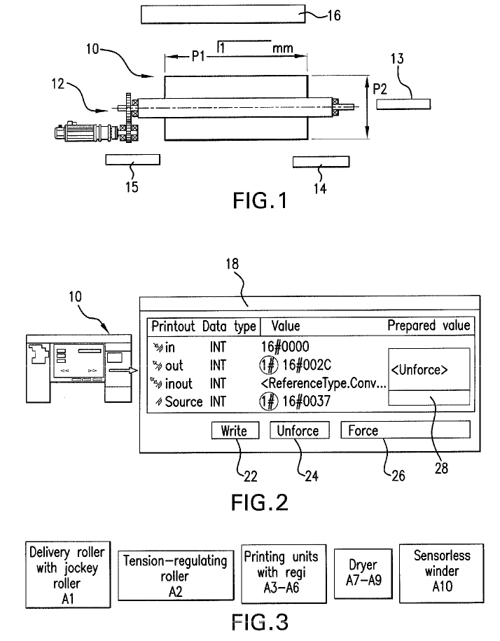

FIG. 1 shows an illustration of a graphic depiction of an information-exchange sequence;

FIG. 2 shows a depiction that illustrates the forcing of parameters; and

FIG. 3 shows a block diagram-type depiction of a machine.

FIG. 1 shows a schematic representation of an advantageous information-exchange sequence. A picture element 12 which visually depicts a drive for an axle is provided within information-exchange sequence 10. Input windows 13, 14, 15 are also provided within this dialog or information-exchange sequence, via which it is possible to set properties of the machine part that are depicted visually by picture element 12. A change that was carried out is visualized using picture element 12. The appearance of picture element 12 may also be modified dynamically (e.g. with/without transmission) depending on the data in the input fields. Individual parameters of the system are also visualized, e.g. double arrow P1 visualizes the web width, and double arrow P2 visualizes a roller diameter. A torque may be specified, e.g. in input field 15 in the lower left, and information about the particular change that was carried out may be output to the user via a further information window 16.

These input and output windows are dialogs that . . . with the FB that is responsible for controlling the machine part of functionality that is visualized in picture element 12.

FIG. 2 shows a depiction that illustrates how parameters are forced. A certain variable may be called up via clicking in dialog 10, and these variables may be displayed in a further window 18. In window 18, the variable may then be set to a certain value (reference numeral 24), or the forcing (reference numeral 26) may be halted, or a new variable may be assigned (reference numeral 22). Related values may be entered via input window 28.

FIG. 3 shows a schematic representation that illustrates a machine according to the present invention. This machine includes several units, e.g. a delivery roller with a jockey roller, a tension-regulating roller, printing units, a dryer, and a winder. These individual components may, in turn, include several drives, each of which is controlled by function blocks. Using the present invention, it is possible to diagnose the individual sections of this machine individually, and, in particular, to influence them in terms of their parameters.

Via the procedure according to the present invention, it is also possible to link to any on-line help system in a more detailed manner, and to couple SPC data to further motion system data.

By coupling the dialogs with the FBs, they become part of the object-oriented FB structure. More specifically, the FB “object” is composed of the actual FBS function block, and it contains at least one dialog. In other words, the dialog is delivered directly with the function block, which means that it need not be installed separately, but rather is present as soon as the function block has been installed.

All features disclosed in the application documents are claimed as being essential to the present invention, provided they are novel compared with the related art, either individually or in combination.

### LIST OF REFERENCE NUMERALS

10 Information-exchange sequence
12 Picture element
13, 14, 15, 18 Input window
16 Output window
22 Input element for writing a variable
24 Input element for forcing a variable
26 Input element for unforcing a variable
28 Input window
P1, P2 Double arrow

What is claimed is:

1. A method for programming and/or diagnosing a stored-program controller that includes at least one programmable function block, a specified programming system being used for programming, and, within the scope of this programming system, variables are specified and information-exchange sequences (10) are used for programming,
wherein
results of the programming are output via a display device during at least one programming mode, and the information-exchange sequences (10) are assigned to the function block and are made available as predefined information-exchange sequences (10) of this programmable function block.

2. The method as recited in claim 1,
wherein
information-exchange sequences (10) may be called up from a program that was written for the stored-program controller.

3. The method as recited in claim 1,
wherein
a directory of a large number of programmable function blocks is available, and the information-exchange sequences (10) may be downloaded via this directory.

4. The method as recited in claim 1,
wherein
at least one variable is set to a predetermined value using an information-exchange sequence (10).

5. The method as recited in claim 1,
wherein
the information-exchange sequences (10) include picture elements (12).

6. The method as recited in claim 1,
wherein
the information-exchange sequences (10) are called up via the implementation part or the declaration part of the SPC program.

7. The method as recited in claim 1,
wherein
internal states of the function block are displayed using at least one information-exchange sequence (10).

8. The method as recited in claim 1,
wherein
help instructions may be called up using an information-exchange sequence (10).
